(19) United States
(12) Patent Application Publication
(10) Pub. No.: US 2010/0036731 A1
(43) Pub. Date: Feb. 11, 2010

(54) ANIMATED AUDIBLE CONTEXTUAL ADVERTISING

(75) Inventor: Riccardo Vieri, Montespertoli (IT)

Correspondence Address: TOLER LAW GROUP, 8500 BLUFFSTONE COVE, SUITE A201, AUSTIN, TX, 78759, US

(73) Assignee: Braintexter, Inc., Austin, TX (US)

(21) Appl. No.: 12/508,258

(22) Filed: Jul. 23, 2009

(30) Foreign Application Priority Data
Aug. 8, 2008 (IT) PO2008A000008

(51) Int. Cl. G06Q 30/00

(52) U.S. Cl. 705/14.53; 705/14.73; 705/14.69; 705/14.68

(57) ABSTRACT

A system is disclosed that includes a processor and a memory including instructions that are executable by the processor. The instructions, when executed by the processor, cause the processor to identify advertisement data associated with an advertisement campaign based on one or more features of a web page requested by a client device. Based on stored user interaction data associated with the client device and the identified advertisement data, a textual component of an advertisement is generated. An animated component is generated based on the textual component, and a text-to-speech conversion is performed on the textual component in order to generate an audible component. The textual component, the animated component, and the audible component are sent to the client device. The animated component and the audible component are initially dormant and are presented at the client device in response to a first client device user action.

### CLAIM OF PRIORITY

This application claims priority from Italian Patent Application No. P02008A000008, filed on Aug. 8, 2008, which is incorporated herein by reference in its entirety.

### FIELD OF THE DISCLOSURE

The present disclosure is generally related to animated audible contextual advertising.

### BACKGROUND

The Internet advertising world is experiencing rapid changes. Performance of regular banner advertising and email marketing is declining, and companies are attracted by innovative forms of advertising, such as pay per performance advertising.

Internet advertising displayed via popup windows may have limited effectiveness and may be annoying. For example, web browsers may be able to prevent such pop up advertising from being displayed. Alternative advertising methods, including “hover ads” based on dynamic hypertext markup language (dhtml), may allow advertisers to overcome the ability of web browsers to block pop up advertising. Such “hover ads” may be positioned within the same web page as the desired web content and may not be retrieved from an external source. Another alternative advertising method requires users to view an advertising web page before viewing the desired web content. However, such alternative advertising may also be annoying to users or otherwise ineffective. Requesting that a user install additional software may also be problematic. Further, advertisements displayed in fixed locations may clutter a web page and potentially distract the user from the web content.

### BRIEF DESCRIPTION OF THE DRAWINGS

FIG. 1 is a flow diagram of a first embodiment of a method of contextual advertising;

FIG. 2 is a flow diagram of a second embodiment of a method of contextual advertising;

FIG. 3 is a flow diagram of a third embodiment of a method of contextual advertising;

FIG. 4 is a block diagram of a first embodiment of a system of contextual advertising;

FIG. 5 is a block diagram of a second embodiment of a system of contextual advertising;

FIG. 6 is an illustrative embodiment of an audible component along with a scrolling textual component, a user interface adapted to enable a user to interact with an advertiser via text messaging, and a user interface adapted to enable a user to interact with an advertiser via a Voice over Internet Protocol (VoIP) call.

FIG. 7 is an illustrative embodiment of an audible component along with a scrolling textual component and a user interface to enable a user to request further information from an advertiser via email or telephone, a user interface adapted to enable a user to request further information from an advertiser via text messaging, and a second advertisement displayed in response to the user requesting further information via text messaging; and

FIG. 8 is an illustrative embodiment of a textual component embedded within web content that may display an animated component along with an audible component in response to a client device user action.

### DETAILED DESCRIPTION

The present disclosure describes systems and method of contextual advertising. Advertising information may be presented to a user at a web page via an animated component and an audible component in response to a user action.

In a particular embodiment, a method is disclosed that includes retrieving web content at a client device. The web content includes advertisement data associated with an advertisement campaign. The method includes displaying a first version of a web page associated with the web content at the client device. The first version of the web page includes at least a textual component related to the advertisement data. One or more client device user actions with respect to the first version of the web page are monitored. In response to detecting a first client device user action, a second version of the web page associated with the web content is displayed. The second version of the web page includes at least one animated component data and at least one audible component related to the advertisement data. The at least one audible component is generated via a text-to-speech conversion based on at least a portion of the textual component. The method also includes determining a portion of the at least one audible component and the at least one animated component presented via the second version of the web page. Based on the portion presented to a user (e.g., a percentage viewed by the user), a message completion indicator is sent from the client device to the server. The message completion indicator provides information related to how the advertisement was presented to the user depending on user behavior.

In an illustrative embodiment, a first amount to bill an advertiser associated with the advertisement campaign is determined based on the portion presented. For example, the first amount may be billed to the advertiser if the entire animated portion of an advertisement is viewed by the user without any follow-up action on the part of the user. Alternatively, a second amount may be billed to the advertiser when a second client device user action (e.g., a follow-up user action) is performed after the first client device user action (e.g., after viewing and/or listening to the initial contextual advertisement). As an example, the second client device user action may include initiating a Voice over Internet Protocol (VoIP) call to the advertiser associated with the advertisement campaign. As another example, the second client device user action may include sending a text message (e.g., a short message service (SMS) message) to the advertiser associated with the advertisement campaign.

Because such follow-up user actions may indicate an increased effectiveness of the advertisement, the second amount billed to the advertiser may be greater than the first amount. Further, the follow-up user action may enable the advertiser to collect further information about the user in order to generate more targeted advertisements. Such advertisements may be targeted to not only the particular user that performed the follow-up action but also to other users. Thus, concatenated actions of the user may be used to track user behavior with respect to advertisements presented at a particular web page.

In another particular embodiment, a system is disclosed that includes a processor and a memory including instructions that are executable by the processor. The instructions, when executed by the processor, cause the processor to identify advertisement data associated with an advertisement campaign based on one or more features of a web page requested by a client device. Based on stored user interaction data associated with the client device and based on the identified advertisement data, a textual component of an advertisement is generated. An animated component of the advertisement is generated based on the textual component, and a text-to-speech conversion is performed on the textual component in order to generate an audible component of the advertisement. The textual component, the animated component, and the audible component of the advertisement are sent to the client device. The animated component and the audible component may be initially dormant and displayable at the client device in response to a particular client device user action.

In an illustrative embodiment, first user interaction data may be received from the client device. The first user interaction data may include information associated with a first client device user action. For example, the first client device user action may include a user mousing over the advertisement or making another mouse movement with respect to the web page. Further, second user interaction data may be received from the client device. The second user interaction data may include information associated with a second client device user action (e.g., a follow-up user action). For example, the second client device user action may include initiating a Voice over Internet Protocol (VoIP) call to an advertiser associated with the advertisement campaign. In one embodiment, the audible component may invite the user to make the VoIP call to receive a special discount. As another example, the second client device user action may include sending a text message to an advertiser associated with the advertisement campaign. As a further example, the second client device user action may include sending a form including user information to the advertiser. The second client device user action may enable the user to receive additional information from the advertiser to supplement information provided by the initial textual, audible, and animated components of the advertisement.

In another particular embodiment, a method is disclosed that includes identifying, at a server, advertisement data associated with an advertisement campaign based on one or more features of a web page requested by a client device. A textual component of the advertisement is generated based on stored user interaction data associated with the client device and based on the identified advertisement data. An animated component of the advertisement is generated based on the textual component. The method includes performing a text-to-speech conversion of the textual component to generate an audible component of the advertisement. The textual component, the animated component, and the audible component of the advertisement are sent from the server to the client device. The method also includes receiving a message completion indicator from the client device. The message completion indicator is based on a portion of the animated component and the audible component presented at the client device (e.g., a percentage of the animated component viewed by the user at the client device and the audible component listened to by the user). An amount to bill an advertiser associated with the advertisement campaign may be determined based on at least the portion presented.

In a particular illustrative embodiment, the method may also include receiving an indication as to whether a client device user action has been performed in response to the animated component and the audible component being presented at the client device. Based on the portion presented and based on whether the client device user action is performed, the amount to bill the advertiser associated with the advertisement campaign may be determined.

Other metrics associated with the presentation of the audible component and the animated component may also be tracked. For example, a time that the first client device user action results in the audible component and the animated component being presented may be tracked. Further, another metric may be based on whether the animated and audible component is replayed. As another example, a web site that the user subsequently visits after the initial web page may also provide valuable information for an advertiser.

In another embodiment, a method is disclosed that includes displaying a first version of a web page at a web browser of a client device. The first version of the web page includes a textual component of an advertisement. The advertisement further includes an animated component and an audible component that are initially dormant and are displayable at the web browser of the client device in response to a first client device user action. The audible component of the advertisement is generated via a text-to-speech conversion based on at least a portion of the textual component. One or more client device user actions with respect to the first version of the web page are monitored. In response to detecting the first client device user action, a second version of the web page is displayed at the web browser of the client device. The second version of the web page includes the animated component and the audible component. In response to detecting a second client device user action, a graphical user interface is displayed that includes at least one selectable option to initiate contact with an advertiser associated with the advertisement. For example, the first client device user action may include mousing over the textual component, and the second client device user action may include mousing over the animated component.

In a particular illustrative embodiment, the at least one selectable option includes an option to initiate a Voice over Internet Protocol (VoIP) call to the advertiser. In another embodiment, the at least one selectable option includes an option to send a short message service (SMS) message to the advertiser. In another embodiment, the at least one selectable option includes an option to submit a form to the advertiser. The form may include one or more of a name, an email address, a telephone number, and a location.

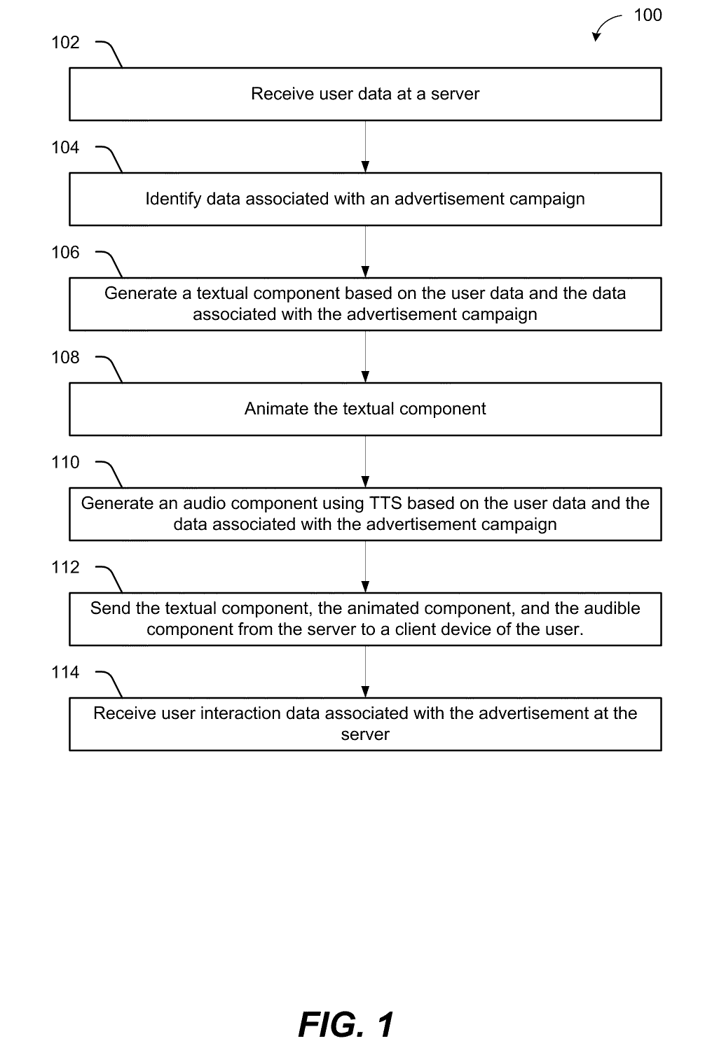

FIG. 1 is a flow diagram of a first embodiment of a method 100 of contextual advertising. The method 100 includes receiving user data at a server, at 102. At 104, data associated with an advertisement campaign is identified. At 106, a textual component of an advertisement is generated based on the user data and based on the data associated with the advertisement campaign. At 108, the textual component is animated. At 110, an audio component of the advertisement is generated using text-to-speech (TTS) based on the user data and based on data associated with the advertisement campaign. At 112, the textual component, the animated component, and the audible component are sent from the server to a client device of the user. At 114, user interaction data, associated with user interaction at the client device with the advertisement, is received at the server.

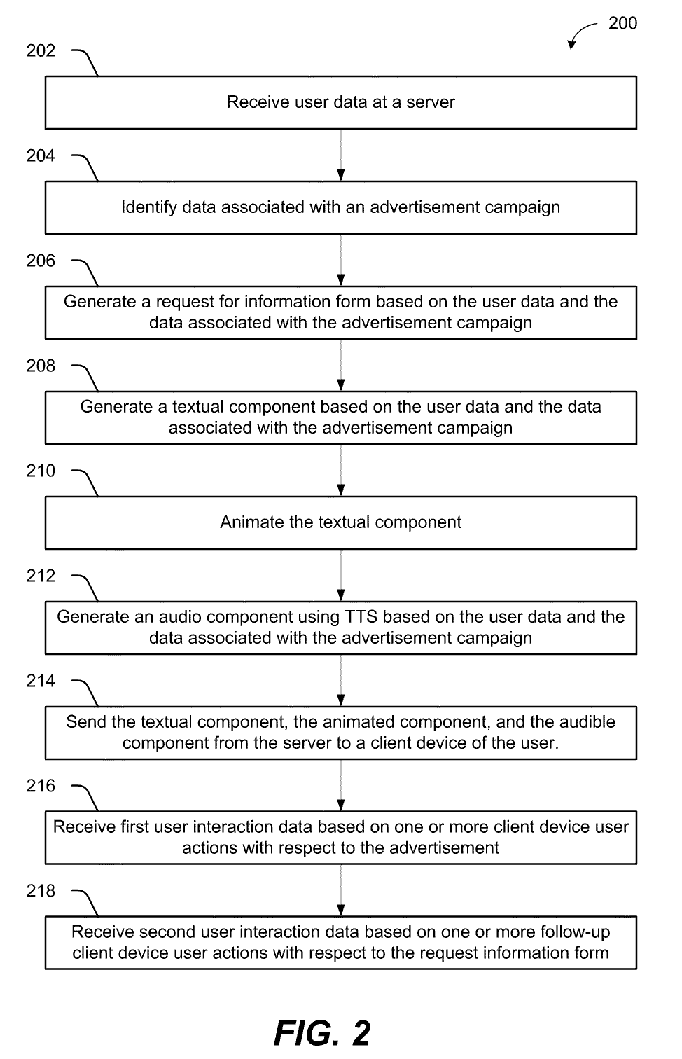

FIG. 2 is a flow diagram of a second embodiment of a method 200 of contextual advertising. The method 200 includes receiving user data at a server, at 202. At 204, data associated with an advertisement campaign is identified. At 206, a request for information form is generated based on the user data and based on the data associated with the advertisement campaign. At 208, a textual component of an advertisement is generated based on the user data and based on the data associated with the advertisement campaign. At 210, the textual component is animated. At 212, an audio component of the advertisement is generated using TTS based on the user data and based on data associated with the advertisement campaign. At 214, the textual component, the animated component, and the audible component are sent from the server to a client device of the user. At 216, first user interaction data associated with the advertisement is received at the server. At 218, second user interaction data associated with the advertisement is received at the server.

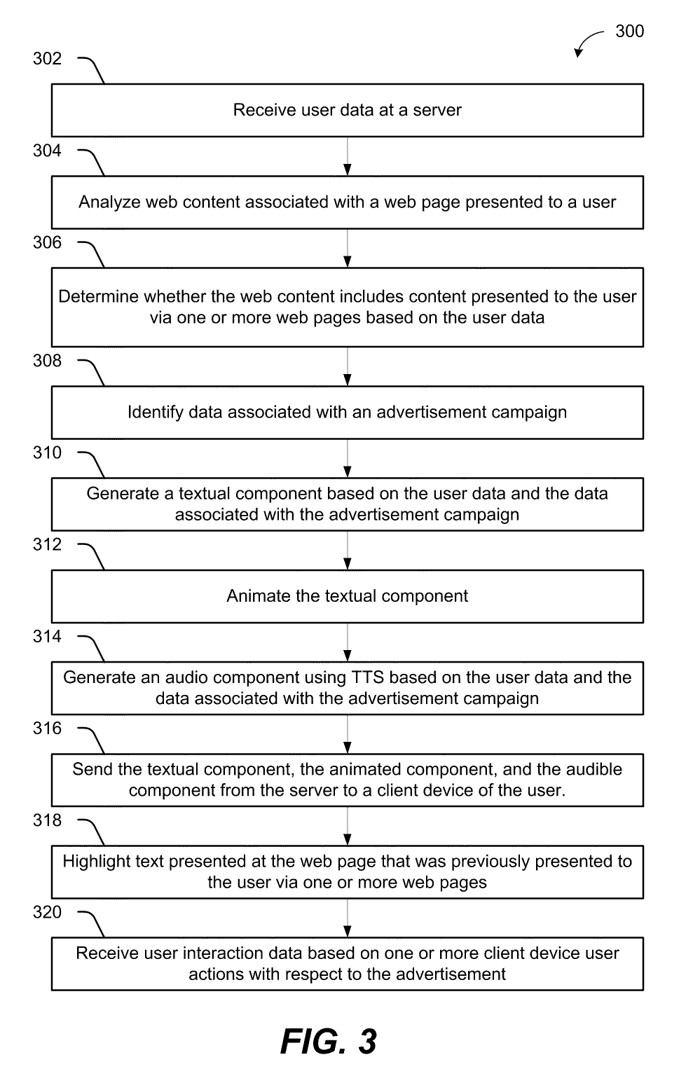

FIG. 3 is a flow diagram of a third embodiment of a method 300 of contextual advertising. The method 300 includes receiving user data at a server, at 302. At 304, web content associated with a web page presented to a user is analyzed. At 306, the method includes determining whether the web content includes content previously presented to the user via one or more web pages based on the user data. For example, the web page may be related to sports, and the user may have previously viewed one or more web pages with sports content. At 308, data associated with an advertisement campaign is identified. For example, an advertisement for tennis shoes may be relevant when the web content is related to sports. At 310, a textual component of an advertisement is generated based on the user data and based on the data associated with the advertisement campaign. At 312, the textual component is animated. At 314, an audio component of the advertisement is generated using TTS based on the user data and based on data associated with the advertisement campaign. At 316, the textual component, the animated component, and the audible component are sent from the server to a client device of the user. For example, the components may be embedded within a web page delivered to the client device via a web browser. As a result, the animated and audible components may be presented via the web browser without installing additional software at the client device. At 318, text presented at the web page that was previously presented to the user via one or more web pages is highlighted. At 320, the method includes receiving user interaction data based on one or more client device user actions with respect to the advertisement.

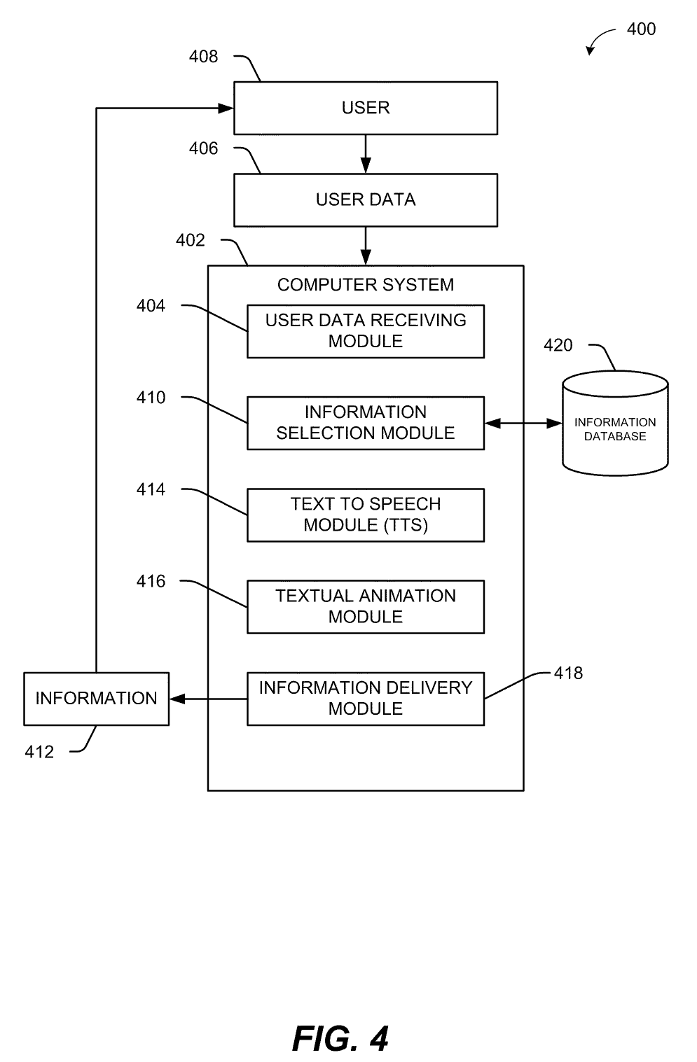

Referring to FIG. 4, a block diagram of an embodiment of a system of contextual advertising is illustrated, at 400. A computer system 402 includes a user data receiving module 404 to receive user data 406 associated with a user 408. The computer system 402 further includes an information selection module 412 to select information 412 (e.g., a textual component of an advertisement) from an information database 420, a text-to-speech module 414 to convert the textual component of the advertisement in order to generate an audible component of the advertisement, and a textual animation module 416 to generate an animated component of the advertisement to be displayed along with the textual component and the audible component. The computer system 402 also includes an information delivery module 418 to deliver the information 412 (e.g., the textual component, the audible component, and the animated component of the advertisement) to the user 408 viewing a web page at a client device.

The client device used by the user 408 to view the web page may include a personal computer (PC), a laptop computer, a mobile device (e.g., a cell phone or a personal digital assistant (PDA), or any other device capable of rendering the web page).

In one embodiment, the computer system 402 is a server computer. The computer system 402 can include a set of instructions that can be executed to cause the computer system 402 to perform any one or more of the methods or computer based functions described herein. The computer system 402 can also be implemented as any other machine capable of executing a set of instructions (sequential or otherwise) that specify actions to be taken by that machine. Further, while a single computer system 402 is illustrated, the term “system” includes any collection of systems or sub-systems that individually or jointly execute a set, or multiple sets, of instructions to perform one or more computer functions. The computer system 402 may include a processor, e.g., a central processing unit (CPU), a graphics processing unit (GPU), or both. Moreover, the computer system 402 may include a main memory and a static memory that can communicate with each other via a bus.

The computer system 402 may include a computer-readable storage medium in which one or more sets of instructions (e.g., software) can be embedded. Further, the instructions may embody one or more of the methods or logic described herein. In a particular embodiment, the instructions may reside completely, or at least partially, within the main memory, the static memory, and/or within the processor during execution by the computer system 402. The main memory and the processor also may include computer-readable media.

In an alternative embodiment, dedicated hardware implementations, such as application specific integrated circuits, programmable logic arrays and other hardware devices, can be constructed to implement one or more of the methods described herein. Accordingly, the present computer system 402 encompasses software, firmware, and hardware implementations.

In an illustrative embodiment, an advertisement may be generated according to a template, where the template is populated with data including at least text data (e.g., a textual component of an advertisement), audio data (e.g., an audio component of an advertisement), or video data (e.g., an animated component of an advertisement), or a combination thereof provided by an advertiser. For example, the template may include one or more avatars, where each of the one or more avatars includes a graphical representation of a character that is adapted to present the advertisement to the user 408. In one embodiment, the avatar may be a male character for delivering audio advertisements using a male voice. In another embodiment, the avatar may be a female character for delivering audio advertisements using a female voice. Alternative embodiments may include avatars representing different age groups, ethnic groups, among other alternatives. For example, a cartoon character may be used to deliver advertisements to younger age groups, while a human avatar may be used to deliver advertisements to older age groups.

In another illustrative embodiment, the advertisement may be selected based on a number of website visits by the user 408. In one embodiment, the number of website visits by the user 408 may be stored at the information database 420. For example, a textual component of a first advertisement may be selected from the information database 420 at least partially based on a comparison of the total number of website visits by the user 408 to a first threshold number of website visits. The first threshold number of website visits may be used to classify users as infrequent or frequent website visitors. For example, if the user 408 has not yet visited a website, the number of website visits by the user 408 would be zero. In this case, the information selection module 410 may select a first textual component of an advertisement. Alternatively, the number of previous website visits by the user 408 may exceed the first threshold number of website visits. In this case, the information selection module 410 may select a second textual component of an advertisement. Similarly, the information selection module 410 may select a third textual component of an advertisement from the information database 420 when the number of previous website visits by the user 408 exceeds a second threshold number of website visits. Thus, textual components of advertisements received by infrequent website visitors may differ from textual components of advertisements received by frequent website visitors. In alternative embodiments, the information selection module 410 may select a textual component of an advertisement based on one or more frequency thresholds, where the thresholds represent the total number of website visits, or the number of website visits to one or more websites, the number or website visits during a predetermined time window, among other alternatives.

Further, the information selection module 404 may select the advertisement based on one or more words associated with the web content of the web page, based on particular Hypertext Markup Language (HTML) text, based on one or more names of files (e.g., pictures or videos) associated with the web page, or based on any other information associated with the web content.

In a particular embodiment, the TTS module 414 determines a language associated with the textual component of the advertisement. In one embodiment, the TTS module 414 uses a distinct voice to generate speech for each of the plurality of languages. The TTS module 414 selects a particular voice from a plurality of voices based on the language. Each voice of the plurality of voices is associated with a different language. The audible component generated by the text-to-speech conversion by the TTS module 414 is based on the particular voice selected.

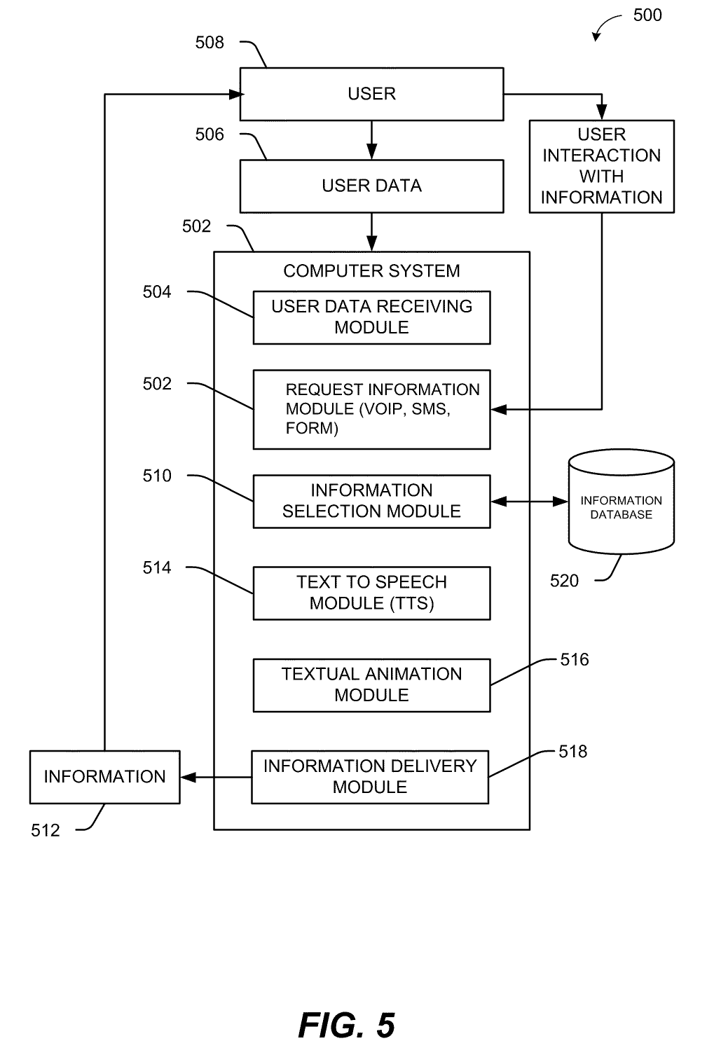

Referring to FIG. 5, a block diagram of another illustrative embodiment of a system of contextual advertising is illustrated, at 500. The illustrative embodiment shown in FIG. 5 includes a request information module 504 to receive information related to interaction of the user 508 with an advertisement.

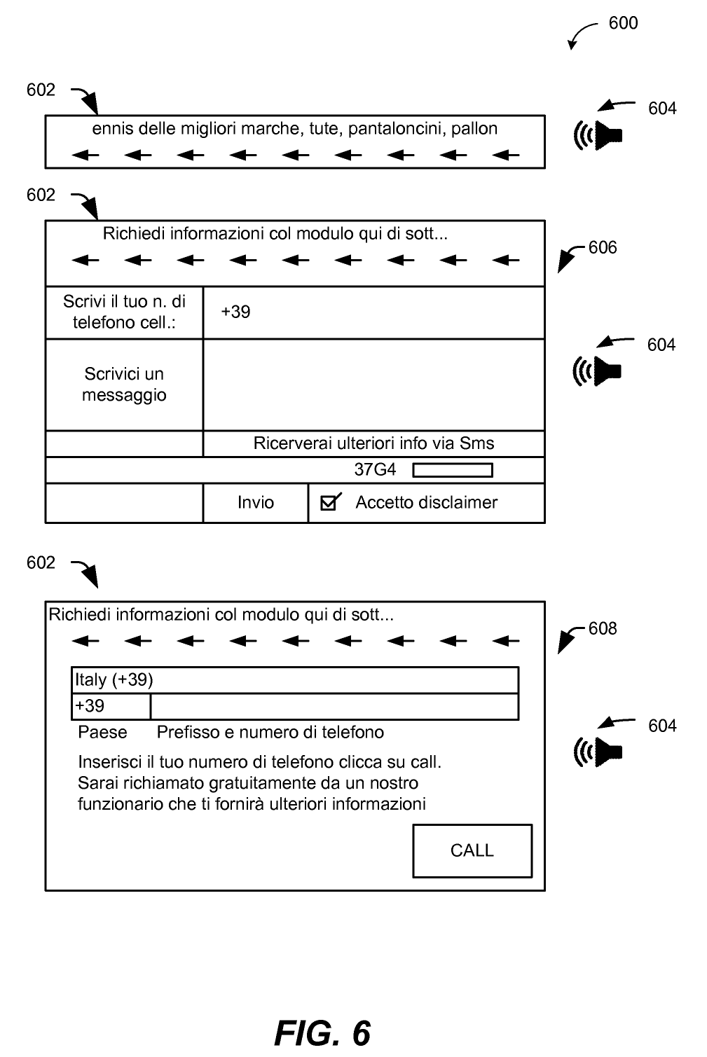

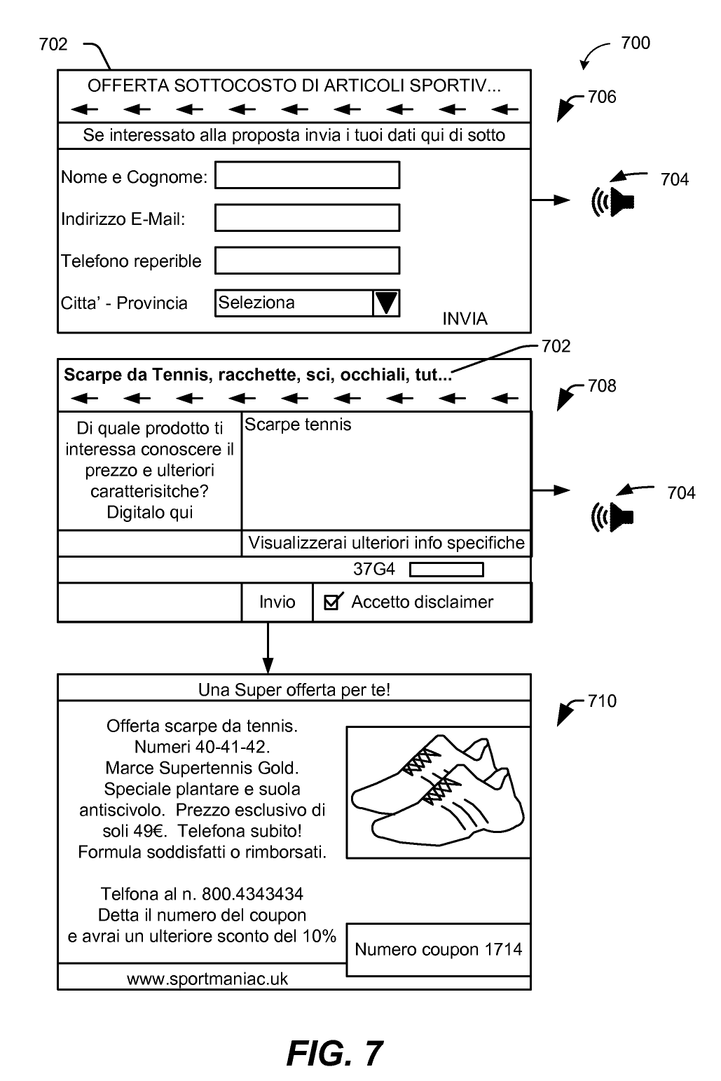

For example, a first client device user action with respect to the advertisement may include mousing over the textual component of the advertisement. In response to the first client device user action, an audible component of the advertisement and the animated component of the advertisement may be presented to the user 508 at the web page. Subsequently, the user 508 may take a second client device user action to initiate a Voice over Internet Protocol (VoIP) call to the advertiser associated with the advertisement campaign. For example, the user may select a “Call” button (See user interface 608 of FIG. 6) displayed at a user interface. Alternatively, a user may mouse over at least one of the textual component, the audible component, or the animated component, resulting in a VoIP option being displayed. Similarly, the second client device user action may initiate sending of a text message (See FIG. 6 and FIG. 7) to the advertiser. Additional client device user actions may be performed. For example, the user may purchase a product or service associated with the advertisement.

The request information module 502 may receive first user interaction data (associated with the first client device user action) from a client device associated with the user 508. The request information module 502 may also receive second user interaction data (associated with the second client device user action) from the client device. The request information module 502 may also receive a message completion indicator from the client device. The message completion indicator is based on a portion of the animated component and the audible component presented at the client device. For example, the user 508 may perform a first client device user action (e.g., a click or a mouse over) with respect to a textual component of the advertisement. As a result, the animated component and the audible component are presented. In some cases, the user 508 may view a portion of the animated component or may view the entire animated component. The animated component may be initiated in the web browser, and the user 508 may minimize the web browser window before the animation is completed. Alternatively, the web browser window displaying the animated component may remain open for the duration of the advertisement. In other cases, the user 508 may initiate presentation of the animated component and the audible component by taking the first client device user action. However, the user 508 may close the web browser window before the advertisement is completed. The user 508 may also browse to a different web page before the animated component and the audible component are completely presented. Thus, the advertisement may be presented for less than the full duration.

An amount to bill an advertiser may be determined based on this information. For example, when only a portion of the audible and animated components are presented, the advertiser may be billed less (e.g., a first amount) than when the audible and animated components are completely presented (e.g., a second amount). As explained above, the user 508 may take a second client device user action (e.g., a follow-up action), such as initiating a VoIP call or sending a text message to the advertiser. The advertiser may be billed a third amount in such cases. The third amount may be greater than the first amount and the second amount.

Typical “pay per click” advertisement models determine an amount to bill an advertiser based on a number of clicks by users. Such advertisement models may be limited by fraudulent clicks, among other limitations. As the number of Internet advertisers grows, the amount charged to advertisers for each “click” may continue to increase. For example, the amount charged to an advertiser for a valuable keyword may increase as more advertisers compete. Further, the effectiveness of a fixed advertisement displayed within a web page may be based on the particular placement of the advertisement (e.g., at the top of the web page versus the bottom of the web page). As a result of the limited targeting ability of conventional advertisement methods, advertisers may be charged for advertisements that may not be presented to users with a particular interest or within a particular demographic.

The system of the present disclosure may enable a “pay per vox” advertisement fee structure. Advertisers can be charged a higher rate as a result of the user 508 requesting that the advertisement is presented audibly and animated, instead of simply as a textual advertisement. An initial user action may indicate that the advertisement has at least been able to capture the attention of the user. Further, advertisers may be charged an even higher rate as a result of the user 508 taking one or more follow-up actions, indicating an enhanced effectiveness of the advertisement with respect to one or more users. Such follow-up actions may indicate an increased level of user interest in the advertised product or service. An increased level of user interest may correlate with an increased likelihood that the particular user will purchase the advertised product or service, resulting in a better return on investment (ROI) for the advertiser.

Alternatively, the amount billed to the advertiser may be determined based on a combination of fixed costs and variable costs. For example, the advertiser may be billed a certain fixed amount for an audible advertisement being generated and a variable amount based on a number of clicks associated with the audible and animated components. As another alternative, advertisers may be charged a fixed monthly fee for textual advertisements to be presented in an audible and animated fashion.

Referring to FIG. 6, an illustrative embodiment of a textual component 602 of an advertisement displayed at a web page is illustrated. In the embodiment illustrated, the textual component scrolls from right to left. Alternatively, the textual component may scroll from left to right, from top to bottom, from bottom to top, may move on the web page in some other fashion, or the textual component 602 may not move on the web page. Further, the textual component 602 may be presented with other effects, such as text appearing suddenly or text appearing in a different font or size compared to the other web content. In a particular embodiment, customization of presentation of the textual component 602 may be performed by an advertiser using a template that includes predetermined colors, characters, and backgrounds, among other possibilities.

The advertisement also includes an audible component 604 presented along with the scrolling textual component 602. FIG. 6 illustrates a particular embodiment of a user interface 606 adapted to enable a user to interact with an advertiser via text messaging. FIG. 6 also illustrates a particular embodiment of a user interface 608 adapted to enable a user to interact with an advertiser via a Voice over Internet Protocol (VoIP) call.

Referring to FIG. 7, an illustrative embodiment of a textual component 702 of an advertisement displayed at a web page is illustrated. The advertisement also includes an audible component 704 presented along with the scrolling textual component 702. FIG. 7 also illustrates a user interface 706 to enable a user to request further information from an advertiser via email or telephone. The user interface 702 enables the user to provide a name, an email address, a telephone number, or a location (e.g., a city or a province), among other possible user information. FIG. 7 also illustrates a particular embodiment of another user interface 708 adapted to enable a user to interact with an advertiser via text messaging. For example, the user may request additional product information from the advertiser. FIG. 7 also illustrates a particular embodiment of a secondary advertisement 710 displayed at the web page in response to the user requesting additional information via text message to the advertiser. In the embodiment illustrated, the text message sent to the advertiser via the user interface 708 is related to tennis. As a result, the advertisement 710 displayed at the web page is related to tennis shoes based on contextual advertising selection. Other advertisements may be selected based on the content of the text message, based on the user, or based on any other contextual information.

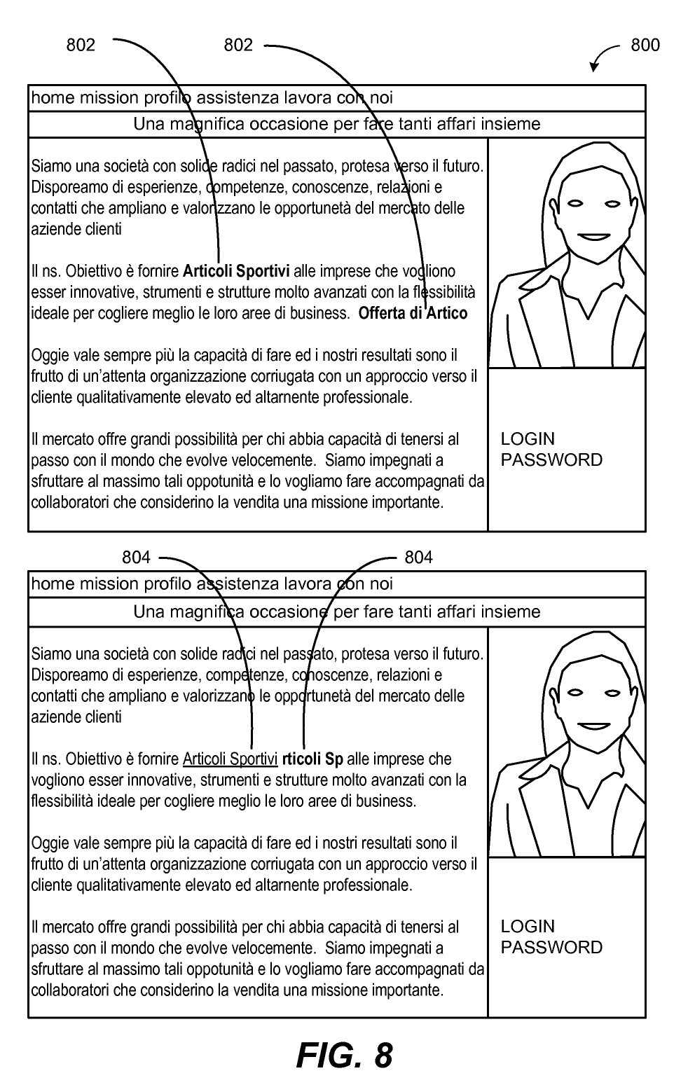

Referring to FIG. 8, an illustrative embodiment of a web page 800 including contextual adverting that includes one or more textual components 802 embedded within desired web content. An animated component along with an audible component may be displayed at the web page in response to one or more client devices user actions. Textual information may vary depending on the web content displayed at the web page. For example, a different textual component 804 may be embedded within different web content.

In a particular illustrative embodiment, the web page is adapted to display the audible component of the advertisement and the animated component of the advertisement upon the user mousing over one or more of the words associated with the textual component of the advertisement. Alternatively, the web page may be adapted to display the advertisement based upon other client device user actions with respect to the web page. The animated component and the audible component may be initially dormant within the web page and may be displayable at the client device in response to the first client device user action. Thus, the animated component and the audible component may be used to provide advertisements at a web page that may be less annoying to users, as they may be presented only in response to particular user actions. Further, the advertisements may be presented without cluttering the web page or occupying valuable space dedicated to the desired web content. In addition, such advertisements do not require the installation of additional software and do not require that the user view the advertisement before viewing the web content.

In one embodiment, the animated component and the audible component are only presented to particular targeted users based on user information. The advertisements may not be presented to users that may not be interested based on previous user behavior, user demographic information, location of the user, or other targeting information. Alternatively, customized animated and audible advertisements may be presented to individual users, based on dynamic factors. For example, based on user location data (e.g., determined based on an Internet Protocol (IP) address or based on Internet Service Provider (ISP)), different animated and audible components may be presented.

As an example, a user in the United States and a user in Italy may be presented with different audible and animated information when viewing the same web page. As a further example, a particular user located in New York viewing a web page related to weather may be presented a scrolling textual component related to weather in New York. In response to a particular client device user action, an audible and animated message may be presented. As an illustrative example, an audio message may be “Dear visitor, browsing from New York, the weather in your city will be sunny for the next twelve hours,” presented in an animated manner. Further, the audible message may invite the particular user to perform a second client device user action, such as “On your right, please find other information.” The user may then perform a second client device user action, such as initiating a VoIP call to an advertiser that provides further information. For example, the advertiser may be a travel services company that advertises low airfares to and from New York airports. Another user located in Rome may be presented a different advertisement or may be presented no advertisement at all.

In another embodiment, particular information may be presented audibly, while other information may only be presented as text. For example, in the case of a natural disaster, information related to the natural disaster may be presented audibly while other less relevant information may be presented only as text. In another particular embodiment, determining whether to present an audible component and an animated component may be based on a total count of characters in a web page. Targeted audible and animated advertisements may be less effective on a web page with a large number of characters. As such, audible and animated components may not be presented on web pages when the number of characters on the web page exceeds a threshold number of characters.

Because advertisements are presented based on user behavior at the web page, there may be no need for the client device to install a special client or other software. Instead, the advertisements may be presented via a web browser displayed at the client device. The system of the present disclosure may be adapted to display audible and animated advertisements based on content included in a Real Simple Syndication (RSS) feed. For example, when the RSS feed is related to news content, the advertisements may refer to content included within the RSS feed. As an example, when a news RSS feed indicates that a particular automobile company reported increased profits and sales, an advertisement from an advertiser with advertising content related to the particular automobile company may accompany the RSS feed when delivered to the user at the client device.

Those of skill would further appreciate that the various illustrative logical blocks, configurations, modules, and algorithm steps described in connection with the embodiments disclosed herein may be implemented as electronic hardware, computer software, or combinations of both. To clearly illustrate this interchangeability of hardware and software, various illustrative components, blocks, configurations, modules, and features have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The methods or algorithms described in connection with the embodiments disclosed herein may be embodied directly in hardware, in a software module executed by a processor, or in a combination of the two. A software module may reside in random access memory (RAM), flash memory, read-only memory (ROM), registers, hard disk, a removable disk, a compact disc (CD) ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an application specific integration circuit (ASIC). In the alternative, the processor and the storage medium may reside as discrete components in a computing device.

The previous description of the disclosed embodiments is provided to enable any person skilled in the art to make or use the disclosed embodiments. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope possible consistent with the principles and features as defined by the following claims.

What is claimed is:

1. A method, comprising:
retrieving web content at a client device, wherein the web content includes advertisement data associated with an advertisement campaign;
displaying a first version of a web page associated with the web content, wherein the first version of the web page includes at least a textual component related to the advertisement data;
monitoring one or more client device user actions with respect to the first version of the web page;
in response to detecting a first client device user action, displaying a second version of the web page associated with the web content, wherein the second version of the web page includes at least one animated component related to the advertisement data and at least one audible component related to the advertisement data, wherein the at least one audible component is generated via a text-to-speech conversion based on at least a portion of the textual component;
determining a portion of the at least one audible component and the at least one animated component presented via the second version of the web page; and
sending a message completion indicator from the client device to the server, wherein the message completion indicator is based on the portion presented.

2. The method of claim 1, wherein a first amount to bill an advertiser associated with the advertisement campaign is determined based on the portion presented, wherein the portion presented includes at least one of a percentage of the audible component presented to a user and a percentage of the animated component presented to the user.

3. The method of claim 2, wherein the amount to bill the advertiser includes a second amount when a second client device user action is performed after the first client device user action, wherein the second amount is more than the first amount.

4. The method of claim 1, wherein the second version of the web page is determined based on one or more frequency thresholds, wherein the one or more frequency thresholds include at least one of a number of website visits and a number of website visits during a predetermined time window.

5. The method of claim 1, wherein the second version of the web page includes a textual component that varies based on displayed web content, and wherein the textual component is presented without cluttering the web page or occupying valuable space dedicated to the web content.

6. The method of claim 4, wherein the second client device user action includes initiating a Voice over Internet Protocol (VoIP) call to the advertiser associated with the advertisement campaign.

7. The method of claim 4, wherein the second client device user action includes sending a text message to the advertiser associated with the advertisement campaign.

8. The method of claim 4, wherein the second client device user action includes sending a form to the advertiser associated with the advertisement campaign, the form including at least one of a name, an email address, a phone number, and a location.

9. A system, comprising:
a processor;
a memory including instructions, that when executed by the processor, cause the processor to:
identify advertisement data associated with an advertisement campaign based on one or more features of a web page requested by a client device;
generate a textual component of an advertisement based on stored user interaction data associated with the client device and the identified advertisement data;
generate an animated component of the advertisement based on at least the textual component;
perform a text-to-speech conversion of the textual component to generate an audible component of the advertisement; and
send the textual component, the animated component, and the audible component of the advertisement to the client device,
wherein the animated component and the audible component of the advertisement are initially dormant and are displayable at the client device in response to a first client device user action.

10. The system of claim 9, wherein the memory further comprises instructions, that when executed by the processor, cause the processor to:
determine a language associated with the textual component; and
select a particular voice from a plurality of voices based on the language, wherein each voice of the plurality of voices is associated with a different language,
wherein the audible component generated by the text-to-speech conversion is based on the particular voice selected.

11. The system of claim 9, wherein the one or features of the web page include a number of characters, and wherein the animated component and the audible component remain dormant in response to the first client device user action when the number of characters exceeds a threshold number of characters.

12. The system of claim 9, wherein the animated component, the audible component, and the textual component are displayable at the client device within a Real Simple Syndication (RSS) feed, the memory further comprising instructions, that when executed by the processor, cause the processor to receive first user interaction data from the client device, the first user interaction data including information associated with the first client device user action.

13. The system of claim 12, wherein the memory further comprises instructions, that when executed by the processor, cause the processor to receive second user interaction data from the client device, the second user interaction data including information associated with a second client device user action.

14. The system of claim 11, wherein the second client device user action includes one of initiating a Voice over Internet Protocol (VoIP) call to an advertiser associated with the advertisement campaign, sending a text message to the advertiser associated with the advertisement campaign, and sending a form including user information to the advertiser associated with the advertisement campaign.

15. A method, comprising:
identifying, at a server, advertisement data associated with an advertisement campaign based on one or more features of a web page requested by a client device;
generating a textual component of the advertisement based on stored user interaction data associated with the client device and the identified advertisement data;
generating an animated component of the advertisement based on the textual component;
performing a text-to-speech conversion of the textual component to generate an audible component of the advertisement;
sending the textual component, the animated component, and the audible component of the advertisement from the server to the client device;
receiving a message completion indicator from the client device, wherein the message completion indicator is based on a portion of the animated component and the audible component presented at the client device; and
determining an amount to bill an advertiser associated with the advertisement campaign based on at least the portion presented.

16. The method of claim 15, further comprising:
receiving an indication as to whether a client device user action has been performed in response to the animated component and the audible component being presented at the client device; and
determining the amount to bill the advertiser associated with the advertisement campaign based on the portion presented and based on whether the client device user action is performed.

17. The method of claim 16, wherein the client device user action includes one of initiating a Voice over Internet Protocol (VoIP) call to an advertiser associated with the advertisement campaign, sending a text message to the advertiser associated with the advertisement campaign, and sending a form including user information to the advertiser associated with the advertisement campaign.

18. The method of claim 16, wherein the amount to bill the advertiser when the client device user action is performed is greater than the amount to bill the advertiser when the client device user action is not performed.

19. The method of claim 18, wherein the client device user action includes closing a web browser displaying the web page before the animated component and the audible component are completely presented.

20. The method of claim 18, wherein the client device user action includes browsing to a different web page before the animated component and the audible component are completely presented.

21. A method, comprising
displaying, at a web browser of a client device, a first version of a web page that includes a textual component of an advertisement, wherein the advertisement further includes an animated component and an audible component that are initially dormant and are displayable at the web browser of the client device in response to a first client device user action, and wherein the audible component is generated via a text-to-speech conversion based on at least a portion of the textual component;
monitoring one or more client device user actions with respect to the first version of the web page;
in response to detecting the first client device user action, displaying a second version of the web page at the web browser of the client device, wherein the second version of the web page includes the animated component and the audible component; and
in response to detecting a second client device user action, displaying a graphical user interface that includes at least one selectable option to initiate contact with an advertiser associated with the advertisement.

22. The method of claim 21, wherein the at least one selectable option includes an option to initiate a Voice over Internet Protocol (VoIP) call to the advertiser.

23. The method of claim 21, wherein the at least one selectable option includes an option to send a short message service (SMS) message to the advertiser.

24. The method of claim 21, wherein the at least one selectable option includes an option to submit a form to the advertiser, wherein the form includes one or more of a name, an email address, a telephone number, and a location.

25. The method of claim 21, wherein the first client device user action includes mousing over the textual component, and wherein the second client device user action includes mousing over the animated component.
